(19) United States
(12) Patent Application Publication
(10) Pub. No.: US 2023/0123813 A1
(43) Pub. Date: Apr. 20, 2023

(54) SYSTEM AND METHOD OF VOICE-BASED ORDERING AND DELIVERY THEREOF

(71) Applicant: Stephen Madison Byrd, Upper Marlboro, MD (US)

(72) Inventor: Stephen Madison Byrd, Upper Marlboro, MD (US)

(21) Appl. No.: 17/503,267

(22) Filed: Oct. 16, 2021

(51) Int. Cl. G06Q 30/02; G06F 16/909; G10L 15/08

(52) U.S. Cl. CPC G06Q 30/0239; G06F 16/909; G10L 15/08; G10L 2015/088

(57) ABSTRACT

The present invention discloses an informative system and method of ordering live business deals, offers, and promotions through actual voice commands of the user in a given geographical area. The system allows the end-user to use voice as input preferably in any natural or local language of the end-user, which is being translated into machine readable form and processed by AI-based speech recognition and synthesis module of the system.

### CROSS-REFERENCE TO RELATED APPLICATIONS

The present application is a Continuation-In-Part application of U.S. patent application Ser. No. 17/408,858 filed on 23 Aug. 2021. This application further claims priority and is further related to U.S. patent application Ser. No. 16/823,370 filed on 19 Mar. 2020, which is incorporated herein by reference.

### FIELD OF INVENTION

The present invention relates to voice-based ordering of live business deals, offers, or promotions to the customers and its delivery thereof, in a voice-based digital assistant system.

### BACKGROUND OF THE RELATED ART

In the digital-driven world, nowadays, people are more reliant upon mobile devices, smartphones, etc, with the ease of getting every human requisite at their fingertips. The trending technology such as artificial intelligence, the Internet of things, Machine learning, and many other emerging ones, help people and businesses and enables and turns consumers to use digital channels to place their business or personalized deals or orders such as the ordering of different commodities; food and beverage items, etc.

The hands-free technology phenomenon is now becoming a standard behavior amongst businesses and end-users. With technological progress, voice control and voice recognition technologies will be the new equivalent of text typing for input, as typing is becoming a thing of the past.

Digital assistants are most commonly used in customer contact centers to manage incoming communication. Digital assistants are complex and are backed with Artificial Intelligence. Especially, the use of Artificial Intelligence and Machine Learning helps customers to check live offers or business deals within a given geographical area hence customizing the end-user experience. As technology evolves, the business approach also revolutionized. The use of digital assistants enabled with artificial intelligence, helps and allows both customers and businesses to dig up live business deals and at the same time, allows customers for ordering and delivery of business deals. The present invention solves the issues of the traditional mode of ordering and functioning of digital assistants and ease customers and businesses to search, order, and get delivered single or multiple business deals in a fraction of seconds.

### DESCRIPTION OF RELATED ARTS

The US granted patent, U.S. Ser. No. 10/043,516B2 discloses an automated voice-based system for the intelligent assistant. It is an information processing system that interprets natural language input in spoken and/or textual form to infer user intent and performs actions based on the inferred user intent. In another prior art, bearing patent number, U.S. Ser. No. 10/909,980B2, it discloses methods, systems, and computer-readable mediums having instructions for implementing machine-learning digital assistants for advanced analytics, procurement, and operations tasks.

Another granted patent, U.S. Pat. No. 9,318,108B2 to Apple Inc., filed by Thomas et al. teaches about an intelligent automated assistant system that engages with the user in an integrated, conversational manner using natural language dialog, and invokes external services when appropriate to obtain information or perform various actions. In yet another patent application US20200311804A1, the invention teaches about voice-based order processing in which an order is placed for a transaction using natural language.

In the patent application KR1020200000381A, Park et al. discloses an AI-based voice ordering system and the method of its implementation. In yet another patent application CN107645566A, Li Zhi et. al discloses a kind of meal delivery robot voice interactive method based on the cloud platform.

In yet another patent application KR101889371B1, Kim et al. teaches about speech recognition order delivery and payment system using a smart device. It enables easy delivery and confirmation of an order menu by voice. In yet another granted patent CN105934791B, filed by Hewlett-Packard, it discloses the system for ordering by the use of voice commands, that is an end-to-end voice ordering and fulfilment system for a retail store.

None of the above-discussed prior arts teaches about the actual voice-based ordering from the displayed business deals. The present invention discloses business deals preferably food-based deals but not limited to that; which may be further ordered by the end-user using voice input preferably in any natural or local language of the end-user.

### SUMMARY OF THE INVENTION

The embodiments of the present invention disclose an informative system and method of ordering live business deals, offers, and promotions through actual voice commands of the user in a given geographical area.

In another embodiment of the present invention, it discloses an informative system and method of accepting voice commands of the end-user to process their search query and present live business deals, promotions or offers as voice output in a given geographical area.

Another embodiment of the present invention discloses the system and method of recognizing any natural or local language of the user as voice commands to process the ordering of live business deals or live offers in a given geographical area. The system has an AI-based speech recognition and synthesis module to accept, recognize and process the natural or local language of the user to transact single or multiple business deals, offers, or promotions. The present invention allows the end-users to place voice orders in their preferred local language of communication.

In yet another embodiment of the present invention, it discloses the system and method of translating the natural or local language of the user into machine-readable form to process the query of the user.

Another embodiment of the present invention discloses an informative system and method of responding to the results of the search query of the user as voice commands and display live business deals, promotions, or offers and return as voice output within a given geographical area using GPS-enabled location mapping. The deals are preferably food-based offers and live deals but certainly may find embodiments in plurality of other areas of interests.

Yet another embodiment of the present invention discloses ordering of simultaneous single or multiple live business deals as voice commands based on the customers GPS-enabled location mapping.

In yet another embodiment of the present invention, the system filters and presents as voice command any expired business deals or expired offers to the user equipment.

### BRIEF DESCRIPTION OF THE ACCOMPANYING DRAWINGS

The accompanying drawings illustrate several embodiments of the invention and, together with the description, serve to explain the principles of the invention according to the embodiments. One skilled in the art will recognize that the particular embodiments illustrated in the drawings are merely exemplary, and are not intended to limit the scope of the present invention.

FIG. 1 illustrates a typical network diagram embodying the present invention.

FIG. 2 illustrates yet another embodiment of the disclosed invention representing the system flow.

FIG. 3 illustrates a block diagram of the AI-based digital voice assistant

FIG. 4 illustrates the flowchart depicting the method of the disclosed invention.

FIG. 5 illustrates an exemplary screenshot of the search page of the present invention in a mobile device

FIG. 6 illustrates yet another exemplary screenshot of the interfaces of the present invention.

FIG. 7 illustrates the database system used for the implementation of the present invention.

FIG. 8 illustrates yet another embodiment of the present invention depicting the flowchart of the voice based ordering via the digital assistant system.

### DETAILED DESCRIPTION OF THE PREFERRED EMBODIMENTS

Unless otherwise defined, all terms (including technical and scientific terms) used herein have the same meaning as commonly understood by one of ordinary skills in the art of this disclosure. It will be further understood that terms, such as those defined in commonly used dictionaries, should be interpreted as having a meaning that is consistent with their meaning in the context of the specification and should not be interpreted in an idealized or overly formal sense unless expressly so defined herein. Well known functions or constructions may not be described in detail for brevity or clarity.

The terminology used herein is for the purpose of describing particular embodiments only and is not intended to be limiting. As used herein, the singular forms “a”, “an” and “the” are intended to include the plural forms as well, unless the context clearly indicates otherwise.

With reference to the use of the words “comprise” or “comprises” or “comprising” in the foregoing description and/or in the following claims, unless the context requires otherwise, those words are used on the basis and clear understanding that they are to be interpreted inclusively, rather than exclusively, and that each of those words is to be so interpreted in construing the foregoing description and the following claims.

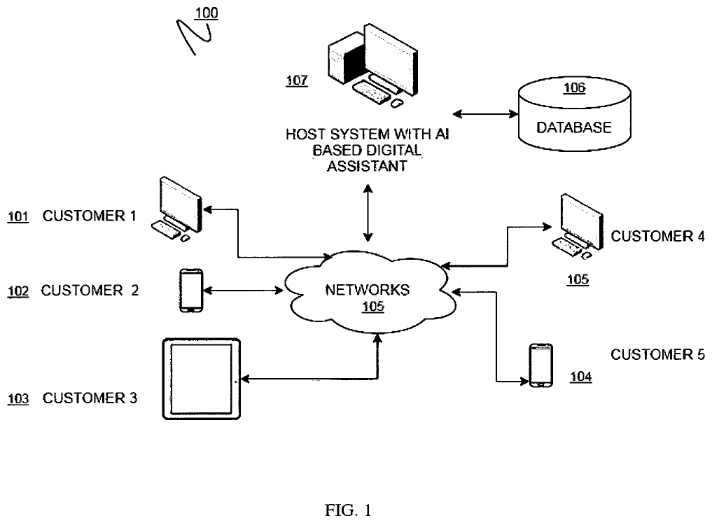

The present invention discloses an AI-based voice-enabled interactive digital assistant system that helps customers to speak to the system and return as a voice response or output, the live business deals, promotions, or offers and order it thereafter for delivery. FIG. 1, shows a typical network diagram embodying the present invention. FIG. 1 illustrates a system 100 that gives an overview of how the present invention works. The system (100) includes a host (108) wherein an interactive digital assistant system is hosted with a supportive database (107). Various customers (101,102,103,104,105) from different locations access the host system (108) via a general-purpose network (106) employing any of the communication devices such as computer, mobile, portable tab, or laptop, etc. Any of these customers may access the digital assistant system and execute voice commands to know about the latest business deals as well as to order them. The host (108) processes the customer requests by retrieving data from the databases in response to the executed input voice command and responds as an output voice command. The database (107) stores merchant information along with the latest offers, promotions, and live deals within a given geographical area, executed and displayed to the customer interface.

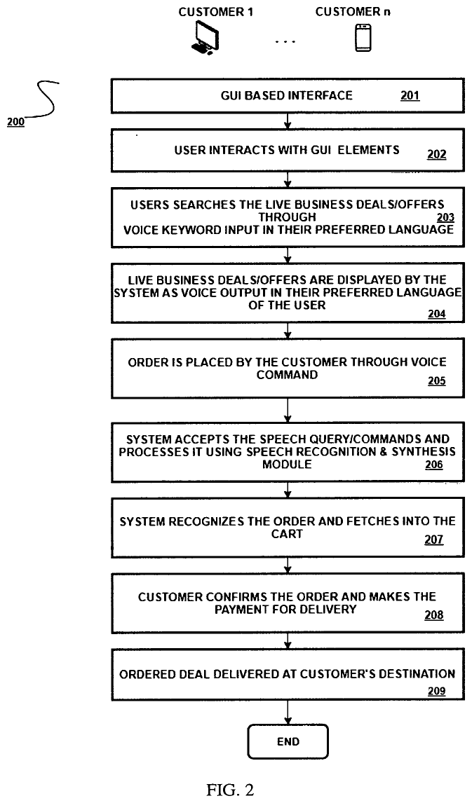

FIG. 2 further describes and illustrates the voice-enabled ordering system 200 and depicts how the overall system works. Customers (customer1, customer2 . . . customer n) through different communication channels access the graphical user interface (201) of the system. The user further interacts with the graphical user interface (202) of the system 200, through voice commands. At the user equipment, the activation of GPS happens that helps customers to receive live business offers or deals based on their current location coordinates. The user searches for live business deals or offers in their preferred language through voice keywords as input, at 203. In addition, the system has a translator module that converts any natural or local language of the user to machine-readable format. At 204, the system interface displays live business deals or offers as voice output in the preferred language of the user. The customer is then allowed to speak certain patterns (for instance, order deal 1, order deal 2 . . . order deal N) as voice commands in their preferred language to confirm and place the order, at 205. The system accepts the speech query or commands of the end-user and processes it using the speech recognition and synthesis module, at 206. The system recognizes the order and fetches the single or multiple deals ordered into the cart at 207. At 208, the user can choose voice commands or preferred keywords to confirm the order and proceed with the payment. The user then has the option to either select the delivery at the user's destination or for pickup, at 209. Finally, the ordered transaction gets completed.

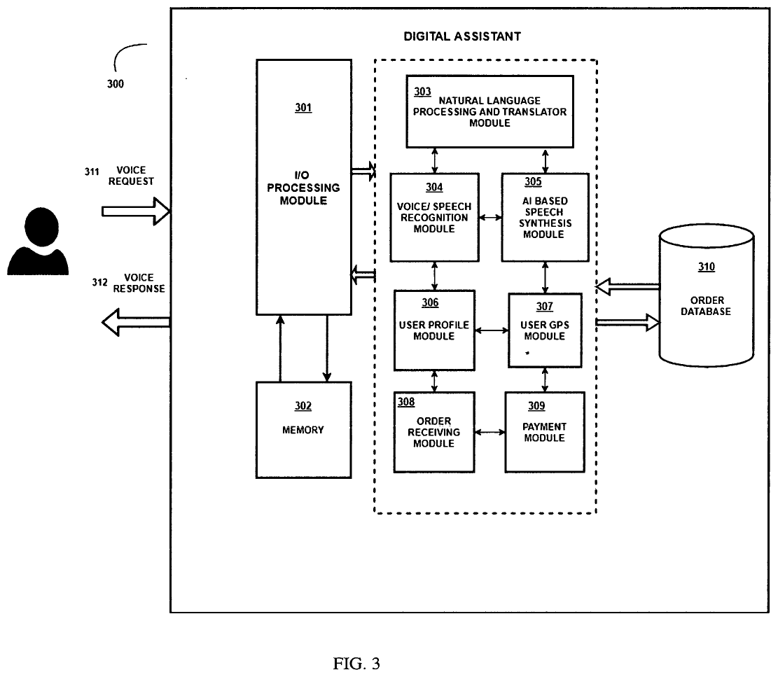

FIG. 3 illustrates a block diagram of the interactive voice-based digital assistant system. In one embodiment it depicts a computing device 300, which includes an input-output processing module (301), memory storage (308) devices, and other modules for processing voice-based digital assistants. It mainly comprises a voice recognition module (304) that allows voice or audio commands received through the microphone of the system and recognizes the local or natural language speech or voice of the user; and is further directed to a natural language processing and translator module (303) which accepts the voice commands of the user in their preferred language and translates it into machine-understandable format; an AI-based speech synthesis module (305) processes the voice command or query of the user to respond with a meaningful result or output, specifically live location-based business deals, offers or promotions. The system 300, in addition, also comprises a GPS module (307, global positioning system) to get the live location of the user to retrieve location-based business deals or offers; a user profile module which acts as an interface between the system and the user to extract and retrieve user profile details; an order receiving module (308) with the help of which the system processes the order received from the user, and a payment module which is directed to the authorized payment portal through the selected payment mode. All these modules are linked to a central database named ‘order database’ (310) which stores information such as user data, voice queries and responses, merchant information, user location, and all the relevant transaction information. The input commands such as voice or audio command/queries are fetched to the interactive digital assistant which is well received and recognized by the voice/keyword recognition module (302), processed by the speech processing and synthesis module (305) which provides meaningful output responses to the user.

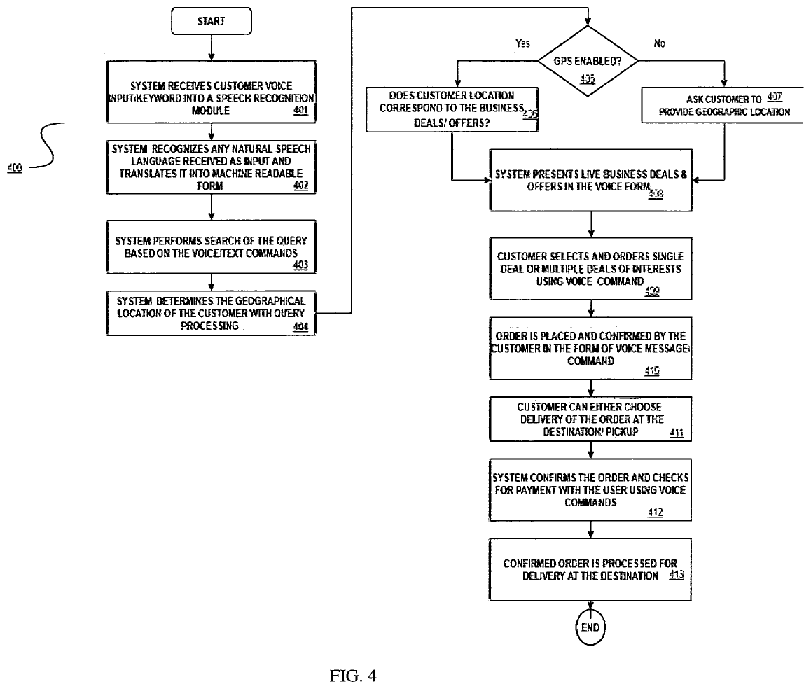

FIG. 4 illustrates a flowchart (400), describing the method of implementation of the present invention. As the interactive voice ordering system 400 gets initiated, the system receives queries from the customer as voice input or voice commands which are identified by the speech recognition module, at 401. The language processing and translator module of the system then help to receive and translate the user's local language or preferred language into computer understandable form, at 402. At 403, the system then performs the search and processing of the query based on the voice or text commands, and at 404, the system also determines the geographical location of the customer with the query processing. The system checks if the GPS is enabled at the user's equipment at 405. Once the GPS is enabled the system checks for the user's location and searches for location-based single or multiple business deals. If the GPS is disabled, the system asks the user to allow them to access their geographical location. At 408, the system outputs live business deals or offer as voice commands. For instance, if Pizzahut has multiple offers for pizza delivery, say 10 offers, then the user can select three or more deals out of ten deals in their local preferred language. The user may order by speaking, for instance, “ORDER deals 1 and 2” from the offers displayed or presented to the user's screen. The user have the freedom to select single or multiple deals into the craft for payment.

At 409, the customer selects and order single or multiple business deals of interest using voice commands in their preferred language, for instance, the user through their mobile can speak out voice command “select order 1 and 2”. The voice of the user is then recognized and processed by the system at the speech recognition and translation module, and it then responds as voice output which will be heard by the user. The order is then placed and confirmed by the customer in the form of a voice message or commands at 410. The customer is either free to choose delivery of the order at the user's destination address or as pickup, at 411. At 412, the system confirms the order and checks for payment with the user using voice commands. Finally, the confirmed order is processed for delivery at the destination, at 413.

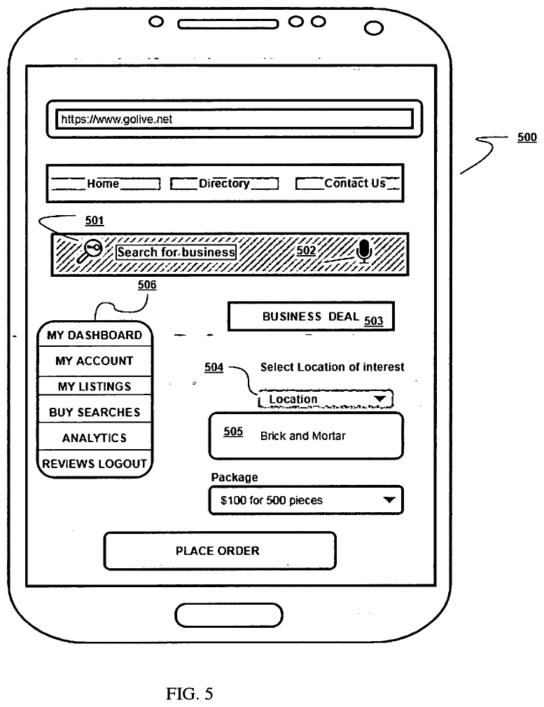

In yet another embodiment of the present invention, it discloses voice-based digital assistants for marketing offers or business deals. FIG. 5 illustrates an exemplary screenshot (500) of the present invention in a portable mobile device. Customers can either choose the text command using the search icon (501) or can use an AI-based voice or speech recognition system which can be achieved by tapping and speaking through the microphone icon (502). The voice-based digital assistant helps the user to search business deals and related queries in their local language through voice commands via the microphone icon (502). The user can speak to the interactive system as voice commands or keywords to select single or multiple business deals from different deal providers and further can place the orders. For instance, the user can speak voice commands such as “PLACE THE ORDERS IN MY CART” through the interface 500 employing a microphone (502). Users are free to use their voice commands in their natural or local language and are free to traverse through the functionalities of the voice-based digital assistant. The home page also provides dashboard items (506) that list customer account, previous searches, previously ordered or bought item lists, analytics of the searches done, etc. The system allows the user to check location-based business deals through voice commands or by selecting the business deals icon (503). It can also select or navigate their current geographical location or location of interest (504) through voice commands. The user finally places an order through their voice commands for the selected single or multiple business deals or offers and proceed for payment of the orders.

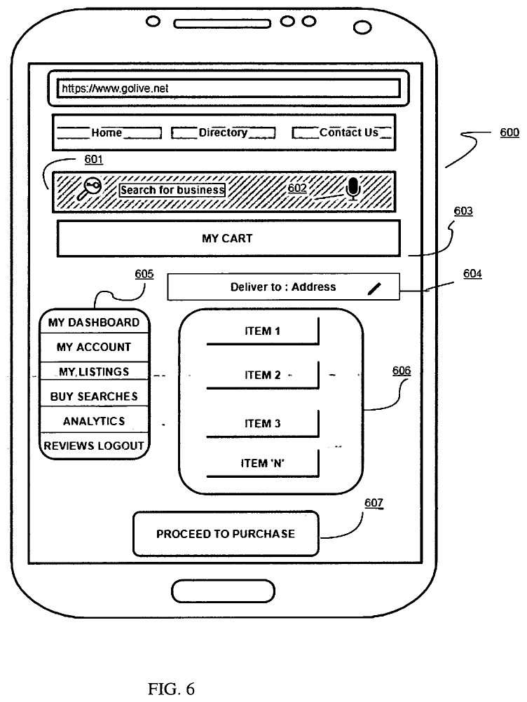

FIG. 6 illustrates another embodiment showing an exemplary screenshot (600) of the interactive AI-based digital voice assistant. The system interface 600 depicts the search tab (601), the microphone (602) to accept voice commands of the user, users dashboard (605), list of business deals in the cart (606), delivery details (604), and payment options (607) and so on. The user can traverse through different pages of the system interface by employing the microphone (602) icon in the digital voice assistant. The interactive page of the digital assistant shows an exemplary view of how the voice assistant resembles. The embodiment of the present invention discloses that the user is free to traverse and order the available business deals by speaking in the user's local language through the AI-based digital voice assistant.

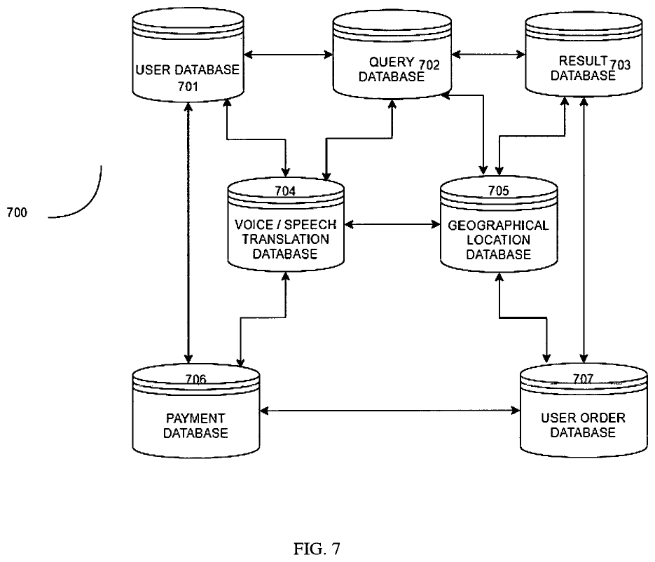

FIG. 7 illustrates the database system of the present invention. The voice-based system for ordering and delivery comprises different databases that store, access, or retrieves the information for processing the queries of the user. System 700 utilizes databases: user database (701), query database (702), result database (703), voice/speech translation database (704), geographical location database (705), user order database (706), and payment database (707). The user database (701) stores customer or user-related profile data. The query database (702) stores customer queries that the customer wishes to search for, it includes business deals or specific user requisite keywords or voice commands of the queries. This data or information in the database is used to fetch or retrieve the results of the queries. The retrieved search result is stored in the result database (703) for further displaying or presenting as voice or text commands to the user end. The voice or speech commands, input from the user is stored and further retrieved from the voice/speech translation database (704), it is also used to store the translated voice commands using the translator module of the system. Further, the system stores geographical data about live business deals or offers, to the geographical location database (705), this is used by the system to retrieve and display location-based business deals or offers to the customers. The system also has a payment database (706) that stores the transaction details of the purchased deal. The user order database (707) stores data related to the user's order, date and location of the order made, history of previous order data, and so on.

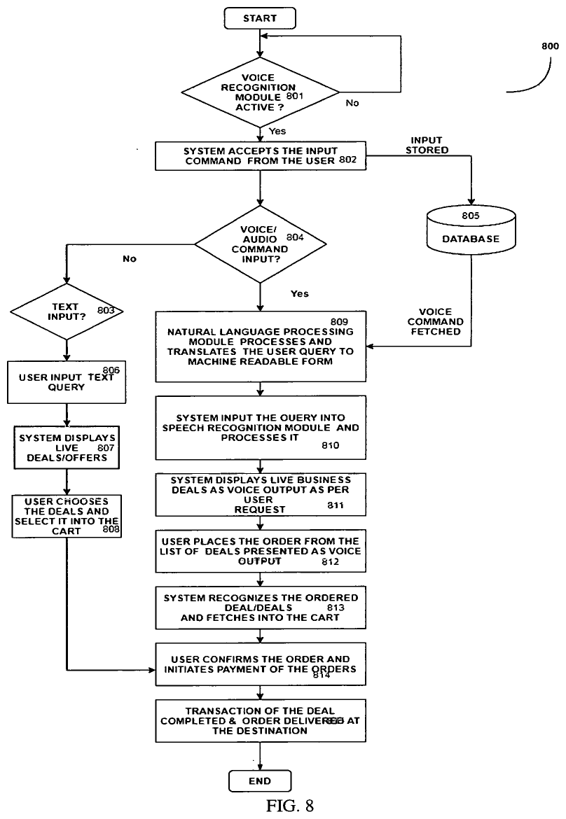

FIG. 8 illustrates another embodiment of the present invention representing the implementation of voice recognition and a voice-based ordering system. The voice-based system 800, comprises a voice recognition module that gets activated when a user accesses the voice ordering system, at 801. The system then accepts input commands that could be either text or voice, received from the user end, at 802, which gets stored in the central database 806. At 804, the system checks whether the input is voice or text input. When the system detects the input as a text query, searches the results of the query from the central database, processes it, and displays back the result (which could be single or multiple business deals available) at the user end or user device, at 803.

Once the system recognizes the input command as a voice or audio command, at 804, the system fetches the voice command or keyword from the database into a natural language processing module. The natural language processing module receives and recognizes any local language spoken by the user. This module further processes the voice-based query and translates it into a machine-readable format, 809. At 810, the system inputs the voice-based query into a speech recognition module and processes it. The system further displays and speaks out the live multiple business deals as voice output at the user end, 811. The user has the option to further place the orders in their preferred language as voice commands, from the listed single or multiple business deals of the providers, 812. At 813, the system recognizes the ordered deal or deals and fetches it into the cart. The user then confirms the order as voice commands and initiates the payment of the orders through different payment modes that the user is comfortable with, 814. Finally, at 815, the user makes the payment and the transaction of the deal gets completed with the order being delivered at the destination of the user or the user may opt to pick up the order.

While a number of preferred embodiments have been described, it will be appreciated by a person skilled in the art that numerous variations and/or modifications may be made in the invention without departing from the spirit or scope of the invention as broadly described. The present embodiments are, therefore, to be considered in all respects as illustrative and not restrictive. The words “customer” and “user”, “AI” and “artificial intelligence” and “voice commands” and “voice inputs”, “natural language”, “local language” and “preferred language” have been used interchangeably in the above-discussed specification. Therefore, the present invention is not limited to the above embodiments that the person should be made under the inspiration of this novel utility of the present invention the same or similar technical solution has, fall within the scope of the present invention.

I/We claim:

1. A system comprising:
a network interface coupled to an artificial intelligence based digital assistant;
a network interface coupled to various computing devices of the customers;
a digital assistant configured to receive and recognize audio commands from the user;
a digital assistant coupled to database storing merchant information;
a digital assistant retrieving data from merchant database based on the voice input command by the user;
a digital assistant configured to order through voice input command from the user;

2. A system according to claim 1 wherein, the merchant information comprise latest offers, business promotions, and live deals within a given geographical area of the user.

3. A system according to claim 2 wherein, the merchant information comprising latest offers, business promotions, and live deals are presented to the user in their preferred local language.

4. A system according to claim 1, comprising one or more processors and memory to communicate with the network interface and merchant database.

5. An interactive digital assistant comprising:
interactive graphical user interface to communicate with the users;
at least one microphone to receive audio input from the user;
at least one typing element module to receive text input from the user;
a global positioning system to receive current location of the user;
a keyword recognition module to process text based commands from the user;
a speech processing and translation module to process voice commands from the user;
a speech recognition module for recognizing speech input from the user;
an Artificial intelligence based speech synthesis module for voice output;
a user profile module with user profile settings options;
an order receiving module to handle purchase orders;
a payment module for secured payments.

6. A method wherein:
an interactive graphical user interface communicates with the users;
at least one microphone receives audio input from the user;
at least one typing element receives text input from the user;
a global positioning system receives current location of the user;
a keyword recognition module processes text based commands;
a speech processing and translation module processes voice commands from the user;
a speech recognition module recognizes speech input from the user;
an Artificial intelligence based speech synthesis module for enabling voice output;
a user profile module has user profile settings options;
an order receiving module handles purchase orders;
a payment module facilitates secured payments.

7. A method according to claim 6 comprising the steps of:
receiving request for assistance via plurality of communication device of the user;
fetching geographical location of the user with the help of GPS enabled user device;
presenting live business promotions, deals and offers to the user in their preferred local language via a plurality of communication devices.

8. A method according to claim 7, further comprising the steps of:
receiving request for assistance comprise receiving either voice or text commands from the user;
fetching geographical location of the user for presenting live deals, promotions and offers around the vicinity of the user.

9. A method according to claim 6, wherein the user may place order for multiple deals at the same time.
